(19) United States
(12) Patent Application Publication
(10) Pub. No.: US 2005/0045260 A1
(43) Pub. Date: Mar. 3, 2005

(54) Heavy duty tire

(76) Inventors: Kiyoto Maruoka, Kobe-shi (JP); Hirotoshi Ohtsuki, Kobe-shi (JP)

Correspondence Address: BIRCH STEWART KOLASCH & BIRCH, PO BOX 747, FALLS CHURCH, VA, 22040-0747, US

(21) Appl. No.: 10/924,895

(22) Filed: Aug. 25, 2004

(30) Foreign Application Priority Data
Aug. 26, 2003 (JP) 2003-301678
Oct. 7, 2003 (JP) 2003-348568
Oct. 7, 2003 (JP) 2003-348569
Dec. 25, 2003 (JP) 2003-430979

(51) Int. Cl. B60C 15/06; B60C 15/00

(52) U.S. Cl. 152/541; 152/543; 152/546; 152/547; 152/552; 152/554

(57) ABSTRACT

It is a subject to restrict occurrence of deficient moldings and to improve the bead durability without harming the advantages provided through a bead wind structure, and for this purpose, a ply turn-up portion of a carcass comprises a winding portion, which continues from a main portion that is bent along a bead core, which extends while being spaced from the bead core, and which inclines at an angle θ that is smaller than 90°. A height of a tip end of the winding portion from an outer surface of the bead core is 3 to 15 mm. A cushion rubber having a complex elastic modulus E1* at 70° C. of 2 to 25 MPa is disposed in a region surrounded by a ply main body portion of the carcass, the bead core and the winding portion.

### BACKGROUND OF THE INVENTION

1. Field of the Invention

The present invention relates to a heavy duty tire of improved bead durability while achieving weight saving.

2. Description of the Prior Art

Tires for heavy load use are filled with high air pressure and are used under demanding conditions of largely applied load. Bead portions are thus firmly reinforced as illustrated in FIG. 6, having a large thickness and also an extremely large weight. For reducing weights of such tires for heavy load use, it has conventionally been suggested for tires of bead structure (also referred to as bead wind structure) as illustrated in FIG. 7 in which a ply turn-up portion a of a carcass is wound around a bead core b substantially round thereof and in which a tip end portion a1 of the ply turn-up portion a is secured between an outer surface of the bead core b in the radial direction and a bead apex rubber c (see Japanese Patent Laid-Open Publication No. 11-321244(1999) and Japanese Patent Laid-Open Publication No. 2000-219016).

In such a bead structure, it is possible to achieve a light-weighted structure of the tire since the length of the ply turn-up portion a is small. Moreover, since the ply turn-up portion a is disconnected in the periphery of the bead core b, stress will hardly act onto the tip end portion a thereof when the tire is deformed. It is accordingly of advantage that damages such as loosing of cords originated from the tip end portion a1 can be restricted.

However, since the above structure is arranged in that the tip end portion a1 is short and in that the degree of bending thereof is large, the bending of the tip end portion a1 tries to return to the original shape in the course of raw tire forming, for instance. As a result, air holes may be formed between the tip end portion a1 and the bead core b so that deficient moldings such as air residues are apt to occur. There also exists a problem in that the carcass cords scratch against the bead core at the tip end portion a1 so that braking damages such as fretting are caused at an early stage.

The present invention thus aims to provide a heavy duty tire that is based on a structure in which the tip end portion a1 is separated from the bead core and in which a cushion rubber having a triangular section of specified physical properties is disposed therebetween to thereby secure advantages exhibited by the bead wind structure while further improving the bead durability and to restrict occurrence of deficient moldings originated from air residues.

### SUMMARY OF THE INVENTION

For achieving such object, the invention according to claim 1 of the present application is a heavy duty tire including a carcass ply in which a ply main body portion that extends from a tread portion over a side wall portion up to a bead core of a bead portion is integrally formed with a ply turn-up portion that is turned up around the bead core from inside to outside in an axial direction of the tire,
wherein the ply turn-up portion comprises a main portion, which is bent along an inside surface of the bead core in an axial direction of the tire, a lower surface thereof in a radial direction, and an outside surface thereof in the tire axial direction, and a winding portion, which continues from the main portion and which extends while being spaced from the bead core,
wherein the turn-up portion extends in an inclined manner with respect to the ply main body portion at an angle θ that is smaller than 90° with respect to an outer surface of the bead core in the radial direction with a height La of a tip end of the winding portion from the outer surface of the bead core in the radial direction being 3 to 15 mm, and
wherein a cushion rubber having a substantially triangular section and with a complex elastic modulus E1* at 70° C. of 2 to 25 MPa is disposed in a region surrounded by the outer surface of the bead core in the radial direction, the winding portion, and the ply main body portion.

In the present descriptions, dimensions of respective parts of the tire represent values that are defined at a 50 kPa filled internal pressure condition in which tires are assembled to regular rims and are filled with an internal pressure of 50 kPa. In this respect, the term “regular rim” denotes a rim with standards being defined for each tire within standardizing systems including standards on which the tires are based, such concretely being a standard rim according to JATMA, a “design rim” according to TRA and a “measuring rim” according to ETRTO.

In the present descriptions, values of the complex elastic moduli of rubber and values of the loss tangents δ represent values measured by using a viscoelasticity spectrometer under conditions of a temperature of 70° C., a frequency of 10 Hz and a dynamic strain rate of 2%.

Since the present invention is arranged in such a manner, it is possible to further improve the bead durability and to effectively restrict occurrence of deficient moldings originating from air residues while securing advantages exhibited by the bead wind structure.

### BRIEF EXPLANATION OF THE DRAWINGS

FIG. 1 is a sectional view illustrating one embodiment of the heavy duty tire according to the present invention;

FIG. 2 is an enlarged sectional view illustrating a bead portion in enlarged form;

FIG. 3 is an enlarged sectional view illustrating a bead portion in enlarged form;

FIG. 4 is a diagram for explaining a definition of an outer surface in case the outer surface of a bead core in a radial direction comprises a non-planar form;

FIG. 5 is an enlarged sectional view illustrating another example of the bead portion;

FIG. 6 is a sectional view illustrating a conventional bead structure of a heavy duty tire; and

FIG. 7 is a sectional view illustrating a conventional bead wind structure.

### DESCRIPTION OF THE PREFERRED EMBODIMENTS

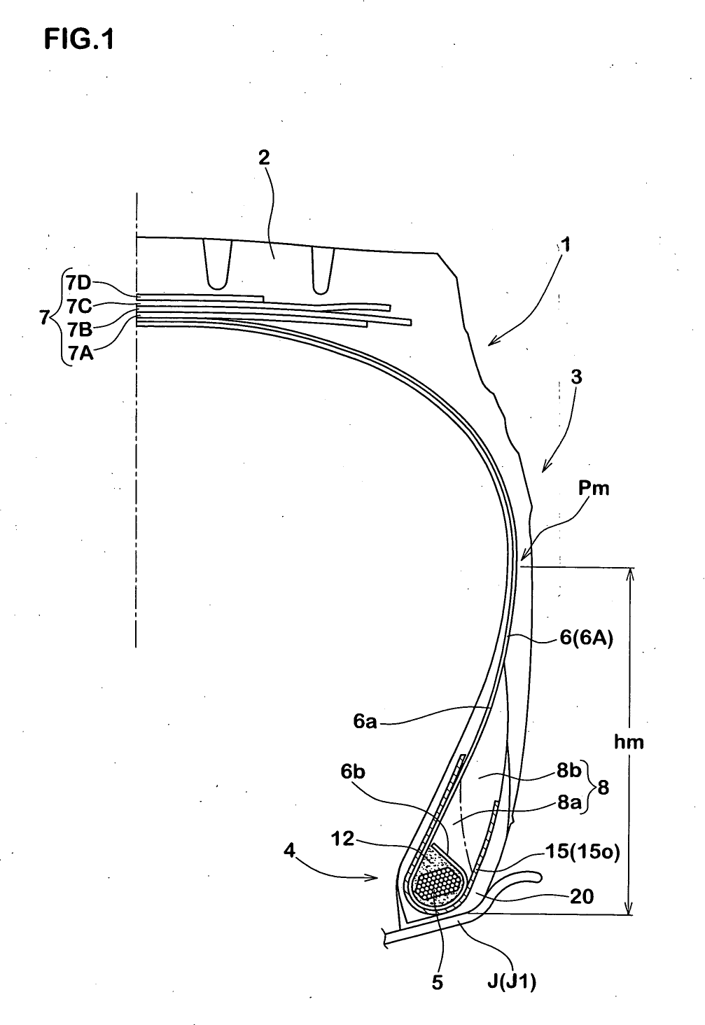

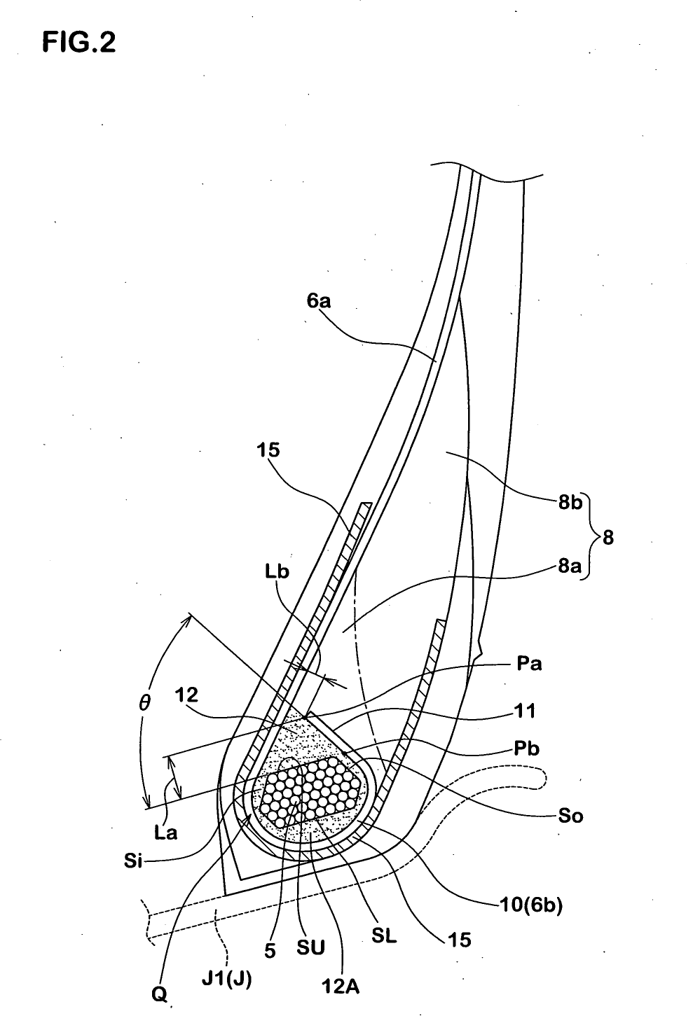

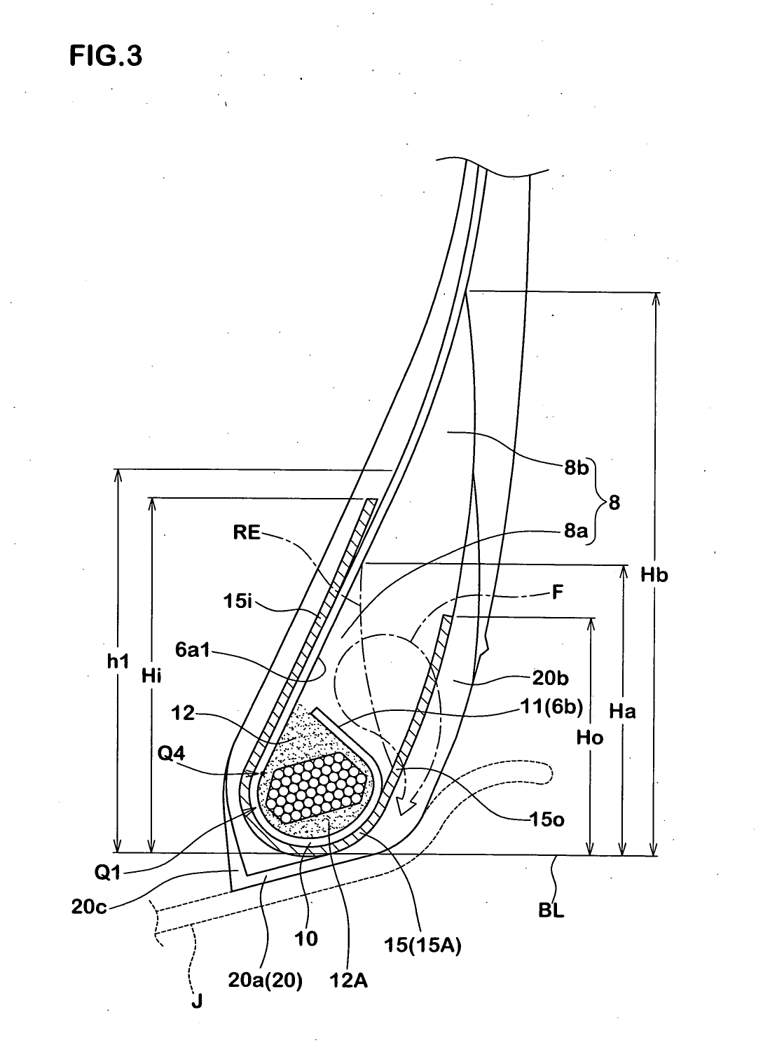

One embodiment of the present invention will now be explained together with illustrated examples. FIG. 1 is a sectional view illustrating a 50 kPa filled condition of the heavy duty tire according to the present invention, and FIGS. 2 and 3 are sectional views illustrating the bead portion in enlarged form.

In FIG. 1, the heavy duty tire 1 is arranged to comprise a carcass 6 that extends from a tread portion 2 over a sidewall portion 3 up to a bead core 5 of a bead portion 4, and a band layer 7 that is disposed outside of the carcass 6 in the radial direction and inward of the tread portion 2.

The band layer 7 is formed of at least two and usually three or more belt plies employing belt boards made of steel The present example illustrtates a case in which the belt layer 7 comprises a four-piece structure composed of a first belt ply 7A on an innermost side in the radial direction in which belt cords are aligned at an angle of, for instance, 45 to 750 in the tire circumferential direction and second to fourth belt plies 7B to 7D in which belt cords are aligned at a small angle of, for instance, 10 to 350 in the tire circumferential direction. The belt plies 7A to 7D serve to increase the belt rigidity and to reinforce the tread portion 2 through hoop effects by being superposed such that belt cords mutually intersect between plies at more than one spot.

The carcass 6 is composed of a single carcass ply 6A in which carcass cords of steel are aligned at an angle of 70 to 90° in the tire circumferential direction. The carcass ply 6A comprises ply turn-up portions 6b that are turned up from inside to outside in the tire axial direction around the bead cores 5 and disposed at both sides of a ply main body portion 6a that extends between bead cores 5, 5 In this respect, each bead core 5 comprises a ring-like core main body in which bead wires made of, for instance, steel are wound in a multi-staged and multiseriate manner. While the bead core 5 is composed of a core main body only in the present example, it is also possible to form a thin wrapping layer around the core main body composed of canvas cloth or a rubber sheet or the like for preventing parting of the bead wires. In the present example, the bead core 5 comprises a flat hexagonal shape having a horizontally long section and its lower surface SL in the radial direction will be substantially parallel to a rim sheet J1 of a regular rim J whereby the fitting force with the rim is improved over a large area. The present example illustrates a case in which the regular rim J is a tubeless 15° tapered rim so that the lower surface SL and the outer surface SU of the bead core 5 in the radial direction are inclined at an angle of substantially 15° with respect to a line in the tire axial direction. The sectional shape of the bead cores 5 may also be orthohexagonal or rectangular according to needs.

Next, according to the tire of the present application, each ply turn-up portion 6b of the carcass 6 is wound around the bead core 5 while its tip end portion is disposed between a cushion rubber 12 and the bead apex rubber 8.

More particularly, the ply turn-up portion 6b is composed of a main portion 10 that is bent along an inside surface Si of the bead core 5 in the tire axial direction, the lower surface SL in the radial direction thereof and an outside surface So in the tire axial direction, and a winding portion 11 that continues to the main portion 10 and which extends upon parting from the outer surface SU of the bead core 5 in the radial direction.

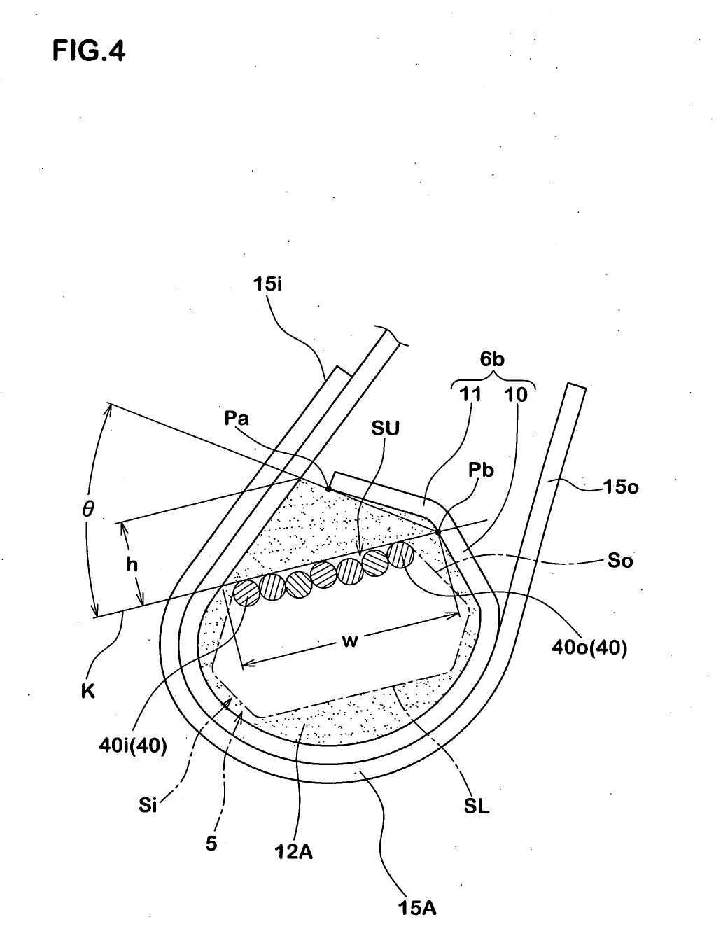

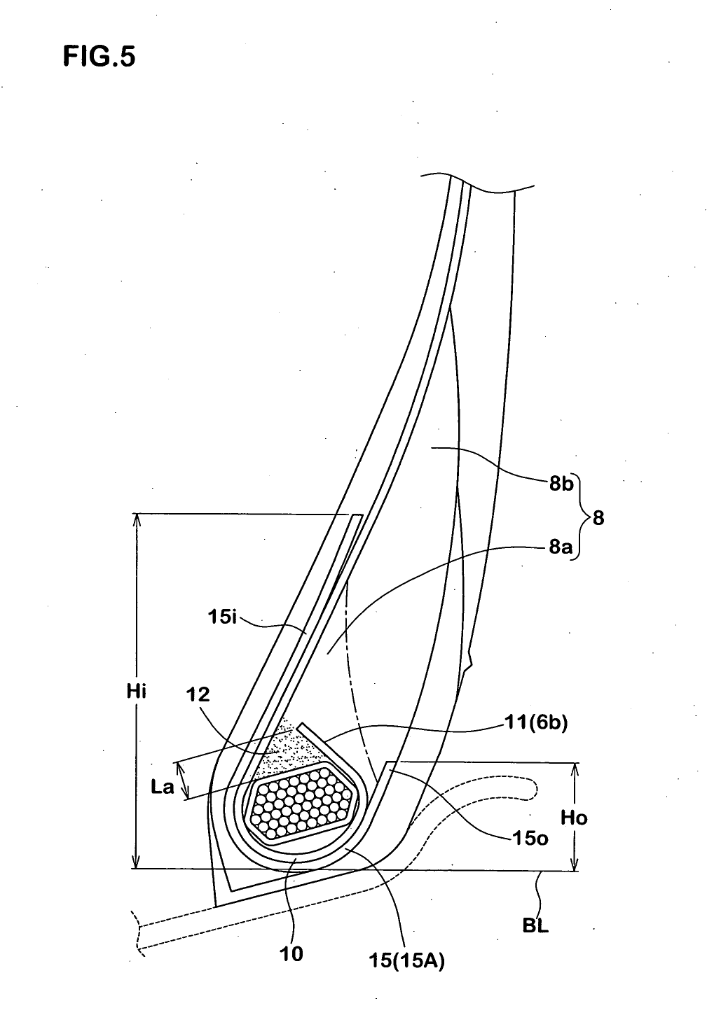

At this time, the winding portion 11 inclines towards the ply main body portion 6a at an angle θ that is smaller than 90° and preferably not more than 75° with respect to the outer surface SU of the bead core 5 in the radial direction. The winding portion 11 denotes a portion that is located outside in the radial direction than an extension of the outer surface SU in the radial direction, wherein the present example illustrates a case in which it comprises a substantially linear shape. The term “substantially linear” allows deformations owing to vulcanization moldings or similar and may include, in addition to straight lines, arcs with a radius of curvature of not less than 100 mm. Since it will not be necessary to bent carcass cords in such a winding portion 11 having a substantially linear shape, no processing such as reforming will be required so that it exhibits superior formability at the time of manufacture. However, it is also possible to form the winding portion 11 to be of a broken linear shape that is bent in a substantially L-shaped manner (as illustrated in FIGS. 4 and 5) and to be of a small arc-like shape having a radius of curvature of less than 100 mm.

In this respect, it may be that the bead core 5 has an outer surface SU in the radial direction that forms a non-planar surface in which the bead wires 40 are aligned not in a linearly arranged order but upon varying in vertical directions as illustrated in FIG. 4 in exaggerated form. In such a case, the outer surface SU in the radial direction is defined as a tangential line K from among the bead wire rows (upper rows) comprising the outer surface SU that contacts bead wire 40o that is located on the outermost side in the radial direction and bead wire 40i that is located on the innermost side in the radial direction. When the winding portion 11 has a curved shape such as a broken linear shape or a bowed linear shape, the angle θ is defined as a angle that the winding portion 11 forms with respect to the outer surface SU in the radial direction of a straight line that connects a lower end Pb of the winding portion 11 that intersects with an extension of the outer surface SU in the radial direction (when the outer surface SU in the radial direction is non-planar, the tangential line K) and the tip end Pa of the winding portion 11.

A height La of the tip end Pa of the winding portion 11 from the outer surface SU in the radial direction is set to be 3 to 15 mm, and the cushion rubber 12 having a substantially triangular section is disposed in a region formed between the outer surface SU of the bead core 5 in the radial direction, the winding portion 11 and the ply main body portion 6a. In this respect, when the bead core 5 includes a wrapping layer, the height La is defined to be the height from the wrapping layer.

By the provision of such a cushion rubber 12 to secure the height La to be not less than 3 mm, it is possible to reduce the degree of bending of the winding portion 11. As a result, it is possible to restrict return-bending of the winding portion 11 and to restrict occurrence of deficient moldings such as air residues. It is also possible to restrict fretting between the carcass cords and the bead cores 5 at the outer surface SU in the radial direction. It is also possible to absorb and ease impact and oscillation received at the tip end Pa when grounding. In this respect, the sectional shape of the cushion rubber 12 is preferably substantially isosceles triangular with the side of the bead core 5 contacting the outer surface SU in the radial direction being the base thereof. A ratio (h/w) of a length w of the base to a height h of the cushion rubber 12 (as illustrated in FIG. 4) is preferably set in the range from 0.25 to 0.75 and further from 0.3 to 0.7. In the present example, the cushion rubber 12 is formed to include a relatively thin film-like sub-portion 12B between the inside surface Si of the bead core 5 in the tire axial direction, the lower surface SL in the radial direction, the outside surface So in the tire axial direction, and the ply turn-up portion 6b. However, it is alternatively possible not to include the sub-portion 12B as in FIG. 5.

When the height La exceeds 15 mm, stress at the time of deformation of the tire will tend to strongly act to the tip end Pa of the winding portion 11 so that damages such as loosing of cords originated from the tip end portion Pa are apt to occur. Accordingly, a lower limit value of the height La is preferably not less than 5 mm and further not less than 7 mm, and an upper limit value thereof not more than 12 mm, and further not more than 10 mm.

It is also important to secure the space Lb between the tip end Pa and the ply main body portion 6a in the range from 1 to 10 mm. Where the space Lb is less than 1 mm, damages of the cords such as fretting will be triggered in which tip ends of carcass cords and carcass cords of the ply main body portion 6a come into contact and be worn owing to variations when forming tires or deformations of the tire at the time of running. When the space Lb exceeds 10 mm, the engaging force of the winding portion 11 will become insufficient so that channeling phenomena of the carcass may occur during running. Accordingly, the lower limit value for the space Lb is preferably not less than 2 mm and the upper limit value thereof not more than 6 mm and further not more than 5 mm and more preferably not more than 4 mm.

Since the height La is not less than 3 mm, stress at the time of deformation of the tire tends to act, to some extent, on the tip end Pa of the winding portion 11. Particularly, since the bead apex rubber 8 of high elasticity adjoins the outside of the winding portion 11 in the radial direction, such stress tends to be focused thereat. It is accordingly necessary to disperse and ease the stress at the cushion rubber 12.

For this purpose, the cushion rubber 12 of the present invention is comprised of rubber having a low elasticity with a complex elastic modulus E1* ranging from 2 to 25 MPa that exhibits superior impact easing effects. In this respect, when the complex elastic modulus E1* exceeds 25 MPa, the flexibility will become inferior so that oscillation and focusing of stress cannot be sufficiently restricted.

Next, as illustrated in FIG. 3, a bead apex rubber 8 extending outside in the tire radial direction with the winding portion 11 being interposed between and a chafer rubber 20 for preventing displacement of the rim provided in a rim contacting region are disposed at the bead portion 4.

The chafer rubber 20 includes a base portion 20a that comprises a bead bottom surface, a clinch portion 20b that comprises a bead outside surface and that rises to a height position exceeding the outer end of a rim flange outward in the radial direction, and a toe portion 20c that covers the bead toe to assume a substantially U-shaped section. Since a large friction is caused between the chafer rubber 20 and the rim J when running, the rubber 20 receives a large shearing force and also generates heat. Such generation of heat causes deteriorations of rubber and shearing force causes cracks in deteriorated rubber. A rubber composition having a complex elastic modulus E2* of 11 to 30 MPa and a loss tangent tan δ of 0.1 to 0.7 is thus employed as the chafer rubber 20.

When the complex elastic modulus E2* is less than 11 MPa, cracks tend to be generated in the chafer rubber 20 after long-time running, and on the other hand, when it is larger than 30 MPa, chipping or similar is apt to occur at the time of rim assembly. It is accordingly preferable to set a lower limit value for the complex elastic modulus E2* to not less than 15 MPa and further to not less than 17 MPa, and to set an upper limit value to not more than 25 MPa and further to not more than 23 MPa. In this respect, it is preferable to set the same to be larger than the complex elastic modulus E1* of the cushion rubber. When the loss tangent tan δ of the chafer rubber 20 is less than 0.1, oscillation tends to be generated at the time of running and deflations or similar are apt to occur, and on the other hand, when it is larger than 0.7, there is a tendency of heat storage so that deterioration is promoted. The loss tangent tan δ is thus preferably set in the range from 0.2 to 0.5 and further from 0.2 to 0.4.

Next, in tires of bead wind structure, the collapsing of the carcass ply 6A at the time of applying load tends to be large. Since the winding portion 11 is located inside of the bead when compared to conventional tires, heat of the brake pad of the vehicle will be easily transmitted to the rubber inside of the bead through the rim and the carcass cords, and thermal softening owing to rise in temperature is apt to occur. Rubber inside of the bead that has thermally softened is pressed by the rim flange when load is applied thereto so that it tends to move to the bead toe side, and the ply turn-up portion 6b tends to move in accordance with this movement.

As a result, damages peculiar to the bead wind structure are seen in which a large shear strain is generated between the carcass ply 6A and the bead core 5 in proximity of an inner end position Q1 of the bead core 5 in the tire axial direction so that loosing of cords is apt to occur.

For restricting such damages owing to heat and for improving the thermal bead durability, the present embodiment is provided with a bead reinforcing layer 15 at the bead portion 4 while it further employs at least one of the following means (1) to (3).

(1) A height Ho in the radial direction of an outer piece 150 of the bead reinforcing layer 15 from a bead base line BL is raised to be of a specified range;
(2) Rubber having a complex elastic modulus E1* of high elasticity side within the above-mentioned range and having an increased sulfur blending amount is employed as the cushion rubber 12; and
(3) Rubber having a specified complex elastic modulus E3* is employed as the bead apex rubber 8.

More particularly, the bead reinforcing layer 15 is comprised of a steel cord ply in which steel cords are aligned at an angle of, for instance, 10 to 40° with respect to a line in the tire circumferential direction, and includes, as illustrated in FIG. 3, at least a curved portion 15A that extends along the main portion 10 of the ply turn-up portion 6b and inward thereof in the radial direction and an outer piece 15o that continues from the curved portion 15A outside thereof in the tire axial direction and that inclines, upon separating from the main portion 10, outside in the radial direction towards outward in the tire axial direction. The present embodiment illustrates an example that assumes a U-shaped form further including an inner piece 15i that continues from the curved portion 15A inside thereof in the tire axial direction and that extends along an inside surface of the ply turn-up portion 6a in the tire axial direction.

The inner piece 15i serves to restrict collapsing of the carcass ply 6A when load is applied thereto and to reduce distortions acting on the tip end Pa of the winding portion 11. However, when a height Hi of the inner piece 15i in the radial direction from the bead base line BL exceeds 70 mm, damages are apt to occur at the tip end thereof owing to focusing of stress. Moreover, inconveniences are caused in that the longitudinal rigidity becomes excess that may lead to worsened riding comfort. From such an aspect, an upper limit value for the height Hi in the radial direction is preferably set to not more than 70 mm and a lower limit value thereof to not less than 10 mm, not less than 25 mm and further to not less than 40 mm. However, such an inner piece 15i may be omitted where necessary. In this respect, the term “bead base line BL” denotes a line in a tire axial direction that extends through the rim diameter position.

According to the method of (1), the height Ho in the radial direction of the outer piece 150 from the bead base line BL is set to be larger than 20 mm but not more than 40 mm for the purpose of improving the thermal bead durability. When the height Ho in the radial direction is set to be higher than 20 mm, the outer piece 15o will exhibit a function as a shielding plate. It will be possible to restrict rubber movements F to the bead toe side (illustrated by the one-dot-chain line in FIG. 3) to prevent damages at the inner end position Q1. However, when the height H in the radial direction exceeds 40 mm, it will become impossible to improve the bead durability, and damages are caused at the tip end of the outer piece 15o owing to focusing of stress. When the height of a ply maximum width point Pm, at which the ply main body portion 6a thrusts most outside in the tire axial direction, from the bead base line BL is set as hm (as illustrated in FIG. 1), the height Ho in the radial direction may also be preferably set in the range of 15 to 34% of the height hm.

In such a case, it is possible to sufficiently secure the thermal bead durability also when the complex elastic modulus E1* of the cushion rubber 12 is set to not more than 13 MPa and further to not more than 7 MPa and thus to a low elasticity side.

According to the method of (2), the complex elastic modulus E1* of the cushion rubber 12 is set to 8 to 25 MPa and thus to a high elasticity side for the purpose of improving the thermal bead durability while rubber having a sulfur blending amount of not less than 5 phr is employed. The first reasons thereof is that it is possible to improve the resistance of the ply turn-up portion 6b with respect to dragging by setting the complex elastic modulus E1* to the high elasticity side even though this somewhat counteracts the stress easing effects at the tip end Pa of the winding portion 11. The second reason is that it is possible to obtain properties with which rubber hardly softens through heat when obtaining the complex elastic modulus E1* of the above range by setting the amount of blending sulfur as a vulcanizing agent by not less than 5.0 phr. Accordingly, it is possible to restrict thermal softening of the cushion rubber 12 even though the bead temperature has been excessively raised so that an even higher resistivity against dragging of the ply turn-up portion 6b can be exhibited. In view of this fact, the amount of blending sulfur is preferably set to not less than 7.0 phr. However, when the amount becomes too large, vulcanization takes place too early so that rubber scorching is apt to occur which may lead to degradations in the adhesiveness with adjoining members. An upper limit value is thus preferably set to not more than 12 phr and further to not more than 10 phr. The value for the complex elastic modulus E1* is also preferably set to be larger than 13 MPa. In this respect, the amount of blending sulfur in general rubber components for tires is approximately 1.0 to 4.0 phr.

In such a case, the thermal bead durability can be sufficiently secured also in case the height Ho of the outer piece 15o of the bead reinforcing layer 15 in the radial direction is reduced to less than 20 mm as illustrated in FIG. 5. However, in view of the thermal bead durability, it is preferable to concurrently employ both the means (1) and (2).

According to the means (3), rubber having a specified complex elastic modulus E3* is used as the bead apex rubber 8. In the present example, the bead apex rubber 8 is composed of an inner apex portion 8a inside in the tire radial direction that adjoins the winding portion 11 and an outer apex portion 8b that extends outside in the tire radial direction with an outside surface RE of the apex portion 8a being a base thereof.

The inner apex portion 8a is formed of a rubber composition having a complex elastic modulus E3* of 20 to 60 MPa. Main functions of the inner apex portion 8a are suppressing the winding portion 11 of the carcass ply 6A and to deform so as to receive distortions, which are caused through collapsing of the ply main body portion 6a when load is applied thereto, at the upper surface SU of the bead core 5 in the radial direction. Accordingly, the engaging force to the winding portion 11 can be improved and movements of the ply turn-up portion 6b in a dragging direction can be restricted.

At this time, when the complex elastic modulus E3* of the inner bead apex portion 8a is less than 20 MPa, the engaging force to the winding portion 11 will be insufficient so that particularly damage restricting effects at the inner end position Q1 at the time of rising of the temperature cannot be exhibited. On the other hand, when the complex elastic modulus E3* exceeds 60 MPa, the elasticity at this portion will be excessively raised so that it will become difficult to receive collapsing of the carcass ply 6A at the time load is applied thereto by the entire bead core. Stress accordingly tends to focus at the tip end of the outer piece 15o of the bead reinforcing layer 15. In view of this fact, it is preferable to set a lower limit value for the complex elastic modulus E3* to not less than 25 MPa and further to not less than 30 MPa. An upper limit value thereof is preferably set to not more than 50 MPa and further to not more than 40 MPa.

The inventors of the present invention have conducted various experiments upon varying the complex elastic moduli E3* for the inner apex portion 8a and the complex elastic moduli E1* for the cushion rubber 12 to find out that it is preferable to set a ratio of the complex elastic modulus E1* for the cushion rubber 12 to the complex elastic modulus E3* for the inner apex portion 8a (E3*/E1*) to not more than 10. More particularly, when the above ratio (E3*/E1*) becomes larger than 10, the difference between elastic moduli of the cushion rubber 12 and the apex protion 8a will become too large so that loosing originated from the difference in elastic moduli is apt to occur at the winding portion 11. An upper limit value for the ratio (E3*/E1*) is thus preferably not more than 7 and further not more than 5. A lower limit value thereof is preferably not less than 1.0.

The outer apex portion 8b is comprised of a rubber composition having a complex elastic modulus E4* that is smaller than the complex elastic modulus E3* of the inner apex portion 8a. A lower limit value for the complex elastic modulus E4* is preferably not less than 3 MPa, and further not less than 3.5 MPa, and an upper limit value thereof is preferably not more than 7 MPa and further not more than 5 MPa. When the complex elastic modulus E4* is less than 3 MPa, the difference between the elastic moduli between the same and the inner apex portion 8a will become too large so that peeling damages are apt to occur from proximate of a boundary between both members. On the other hand, when it exceeds 7 MPa, the rigidity of the entire bead portion 4 will become too high so that damages of the outer apex portion 8b proximate of the outer end thereof tend to occur.

In this respect, a height Hb of the outer apex portion 8b in the radial direction from the bead base line BL is in the range of 160 to 280% of a height Ha of the inner apex portion 8a in the radial direction from the bead base line BL, and the height Hb in the radial direction is in the range of 36 to 43% of a height of the tire section.

The outside surface RE is preferably formed as a smooth arc-like shape that is inclined inward in the tire radial direction towards the outside in the tire axial direction whereby distortions owing to collapsing of the ply main body 6a can be effectively converted into pressing force to the winding portion 11.

In this respect, the thermal bead durability can be sufficiently secured on a single basis also by the means of (3). Accordingly, the height Ho of the outer piece 150 of the bead reinforcing layer 15 in the radial direction can be reduced to less than 20 mm, and the complex elastic modulus E1* of the cushion rubber 12 can be set to the low elasticity side of not more than 13 MPa and further to not more than 7 MPa. However, it is possible to combine the same with at least one or both of the means of (1) and (2) in view of the thermal bead durability.

In the present embodiment, for achieving further downsizing of the bead portion 4, reducing the weight thereof and improving the durability owing to the reduction of thermal storage accompanying the same, the ply main body portion 6a comprises a straight linear portion 6a1 that extends linearly from an inner end position Q4 in the radial direction towards outside thereof in the radial direction, wherein a height h1 of the straight linear portion 6a1 from the bead base line BL is set to be not less than 50%, not less than 60% and further to not less than 70% of the height Hb of the bead apex rubber 8 in the radial direction.

While particularly preferred embodiments of the present invention have been explained in detail so far, the present invention is not limited to the illustrated embodiments but may be embodied upon modifying the same into various forms.

### EXAMPLES

Radial tires for heavy load use having a tire size of 11R22.5 and having a bead structure as illustrated in FIG. 1 were manufactured by way of trial on the basis of the specifications of Tables 1 to 5, whereupon tests on bead strength, bead durability (general), thermal bead durability, rate of incidence of deficient moldings, and changes over time of the bead base were conducted for the respective sample tires. In this respect, specifications other than those listed in the table were common to all of the tires.

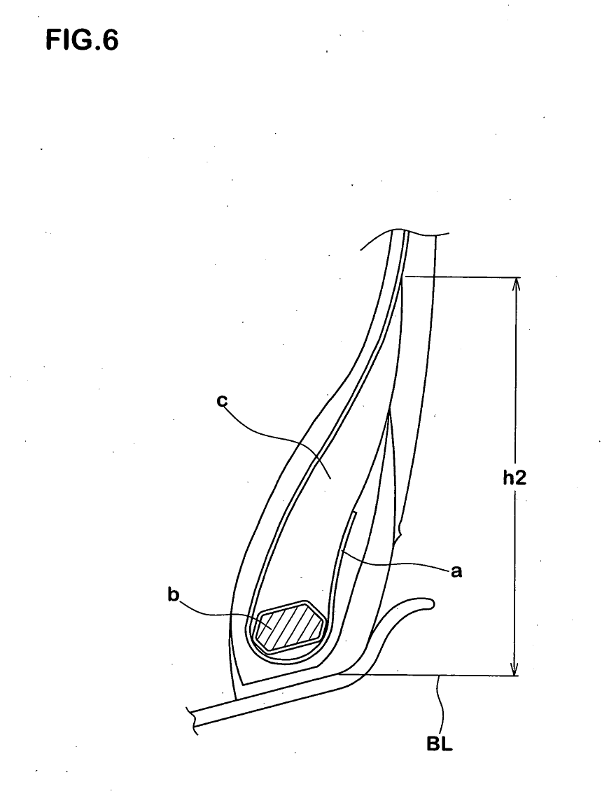

In this respect, the Comparative Example 1 was of conventional arrangement in which the ply turn-up portion of the carcass is wound up along the outside surface of the bead apex rubber as illustrated in FIG. 6, wherein a height h2 of the ply turn-up portion from the bead base line was 65 mm.

<Bead Strength>

The sample tires were respectively mounted to rims (7.50×22.5), and upon filling water from a valve into the interior of the tire, the destructive water pressure at which the tire burst was measured. The measuring results are indicated as indices with the destructive water pressure of the Comparative Example 1 being 100, and the larger the numeric value is, the higher the bead strength is.

<Bead Durability (General)>

A drum tester was employed to make respective sample tires run on a drum with the conditions being 7.50×22.5 for the rim, 700 kPa for the internal pressure and 27.25 kN×3 for the longitudinal load at a velocity of 30 km/h. The running time until damages were generated at the bead portion was indicated as indices with that of the Comparative Example 1 being 100 in Tables 1 to 4. In Table 5, indices were indicated with the Example D1 being 100. The larger the numeric value is, the more superior the bead durability is.

<Thermal Durability>

Bead durability tests similar to the above-mentioned one were executed in a condition in which the rim was heated to 130° C., and the running time until damages were generated at the bead portion was indicated as indices with that of the Comparative Example 1 being 100 in Tables 1 to 4. In Table 5, indices were indicated with the Example D1 being 100. The larger the numeric value is, the more superior the bead durability is. In this respect, damages were caused in the thermal bead durability tests that were due to loosing of cords at inner end positions of the bead core in the tire axial direction.

<Rate of Incidence of Deficient Moldings>

The respective sample tires, 100 pieces for each, were manufactured by way of trial for measuring the rate of incidence of deficient moldings. Measurement was performed by scanning the tires with a CT scanner and defectives were defined to be such that included dead air spaces between the bead core and the ply turn-up portion. The smaller the numeric values are, the more favorable they were with smaller fraction defectives.

<Changes Over Time of the Bead Base>

The sample tires having a rim of 7.50×22.5 and an internal pressure of 700 kPa were mounted to rear wheels of a vehicle (a dump track with a specific capacity of 20 tons) for running over one hundred thousand kilometers whereupon the tires were removed from the rim for measuring changes in angles of the bead bottom surface when compared to fresh ones. The smaller the numeric values were, the more favorable they were with smaller changes in angles of the bead base.

TABLE 1

| | | Comparative | Comparative | Comparative | Example | Example | | Example |
|---|---|---|---|---|---|---|---|---|
| | | Example A1 | Example A2 | Example A3 | A1 | A2 | Example A3 | A4 |
| Specification | Bead structure | — | Bead wind | Bead wind | Bead wind | Bead wind | Bead wind | Bead wind |
| of bead | | (FIG. 6) | (FIG. 2) | (FIG. 2) | (FIG. 2) | (FIG. 2) | (FIG. 2) | (FIG. 2) |
| portion | Height La <mm> | — | 2 | 17 | 8 | 8 | 8 | 8 |
| | Cushion rubber | — | 4 | 4 | 2 | 17 | 4 | 4 |
| | Complex | | | | | | | |
| | elastic | | | | | | | |
| | modulus E1* | | | | | | | |
| | <MPa> | | | | | | | |
| | Chafer rubber | — | 18 | 18 | 18 | 18 | 8 | 37 |
| | Complex | | | | | | | |
| | elastic | | | | | | | |
| | modulus E2* | | | | | | | |
| | <MPa> | | | | | | | |
| | tan δ | — | 0.15 | 0.15 | 0.15 | 0.15 | 0.07 | 0.85 |
| Test results | Bead strength | 100 | 125 | 85 | 120 | 120 | 120 | 120 |
| | Bead | 100 | 120 | 80 | 50 | 65 | 75 | 80 |
| | durability | | | | | | | |
| | (general) | | | | | | | |
| | Rate of | 0 | 80 | 0 | 0 | 0 | 0 | 5 |
| | incidence of | | | | | | | |
| | defective | | | | | | | |
| | moldings <%> | | | | | | | |
| | Change in | 13 | 7 | 18 | 9 | 9 | Occurence | 6 |
| | angle of bead | | | | | | of more | |
| | base (deg) | | | | | | than 10 | |
| | | | | | | | cracks | |

TABLE 2

| | | | | | | | Example | Example |
|---|---|---|---|---|---|---|---|---|
| | | Example A5 | Example A6 | Example A7 | Example A8 | Example A9 | A10 | A11 |
| Specification | Bead structure | Bead wind | Bead wind | Bead wind | Bead wind | Bead wind | Bead wind | Bead wind |
| of bead | | (FIG. 2) | (FIG. 2) | (FIG. 2) | (FIG. 2) | (FIG. 2) | (FIG. 2) | (FIG. 2) |
| portion | Height La <mm> | 8 | 11 | 5 | 8 | 8 | 8 | 8 |
| | Cushion rubber | 4 | 4 | 4 | 11 | 4 | 4 | 4 |
| | Complex | | | | | | | |
| | elastic | | | | | | | |
| | modulus E1* | | | | | | | |
| | <MPa> | | | | | | | |
| | Chafer rubber | 18 | 18 | 18 | 18 | 12 | 27 | 18 |
| | Complex | | | | | | | |
| | elastic | | | | | | | |
| | modulus E2* | | | | | | | |
| | <MPa> | | | | | | | |
| | tan δ | 0.15 | 0.15 | 0.15 | 0.15 | 0.12 | 0.5 | 0.15 |
| Test results | Bead strength | 125 | 115 | 125 | 110 | 125 | 125 | 125 |
| | Bead | 120 | 110 | 120 | 115 | 120 | 120 | 110 |
| | durability | | | | | | | |
| | (general) | | | | | | | |
| | Rate of | 0 | 0 | 2 | 0 | 0 | 1 | 0 |
| | incidence of | | | | | | | |
| | defective | | | | | | | |
| | moldings <%> | | | | | | | |
| | Change in | 9 | 12 | 7.5 | 9 | 14 | 6 | 9 |
| | angle of bead | | | | | | | |
| | base (deg) | | | | | | | |

TABLE 3

| | | | | | | Ex- | Ex- | Com- | Com- | Com- | | | | Com- |
|---|---|---|---|---|---|---|---|---|---|---|---|---|---|---|
| | Ex- | Ex- | Ex- | Ex- | Ex- | am- | am- | parative | parative | parative | Ex- | Ex- | Ex- | parative |
| | ample | ample | ample | ample | ample | ple | ple | Ex- | Ex- | Ex- | ample | ample | ample | Exam- |
| | B1 | B21 | B3 | B4 | B5 | B6 | B7 | ample B1 | ample B2 | ample B3 | B8 | B9 | B10 | ple B11 |
| Bead | Bead | Bead | Bead | Bead | Bead | Bead | Bead | — | Bead wind | Bead wind | Bead | Bead | Bead | Bead |
| structure | wind | wind | wind | wind | wind | wind | wind | (FIG. 6) | (FIG. 2) | (FIG. 2) | wind | wind | wind | wind |
| | (FIG. | (FIG. | (FIG. | (FIG. | (FIG. | (FIG. | (FIG. | | | | (FIG. | (FIG. | (FIG. | (FIG. 2) |
| | 2) | 2) | 2) | 2) | 2) | 2) | 2) | | | | 2) | 2) | 2) | |
| Height La | 7 | 13 | 4 | 7 | 7 | 7 | 7 | — | 2 | 17 | 7 | 7 | 7 | 7 |
| <mm> | | | | | | | | | | | | | | |
| Space Lb | 4 | 4 | 4 | 8 | 4 | 4 | 4 | — | 4 | 4 | 0.5 | 12 | 4 | 4 |
| <mm> | | | | | | | | | | | | | | |
| Cushion | | | | | | | | | | | | | | |
| rubber | | | | | | | | | | | | | | |
| Complex | 15 | 15 | 15 | 15 | 9 | 22 | 15 | — | 15 | 15 | 15 | 15 | 7 | 30 |
| elastic | | | | | | | | | | | | | | |
| modulus E1* | | | | | | | | | | | | | | |
| <MPa> | | | | | | | | | | | | | | |
| Sulfur | 12 | 12 | 12 | 12 | 7 | 15 | 12 | — | 12 | 12 | 12 | 5 | 5 | 18 |
| blending | | | | | | | | | | | | | | |
| amount | | | | | | | | | | | | | | |
| <phr> | | | | | | | | | | | | | | |
| Bead | | | | | | | | | | | | | | |
| reinforcing | | | | | | | | | | | | | | |
| layer | | | | | | | | | | | | | | |
| Height Hi | 55 | 55 | 55 | 55 | 55 | 25 | 0 | 55 | 55 | 55 | 55 | 55 | 55 | 55 |
| <mm> | | | | | | | | | | | | | | |
| Height Ho | 15 | 15 | 15 | 15 | 15 | 15 | 15 | 25 | 15 | 15 | 15 | 15 | 15 | 15 |
| <mm> | | | | | | | | | | | | | | |
| Bead | 125 | 105 | 125 | 110 | 113 | 115 | 105 | 100 | 125 | 85 | 120 | 75 | 120 | 100 |
| strength | | | | | | | | | | | | | | |
| Bead | 120 | 107 | 120 | 110 | 110 | 115 | 102 | 100 | 120 | 80 | 50 | 120 | 120 | 70 |
| durability | | | | | | | | | | | | | | |
| (general) | | | | | | | | | | | | | | |
| Thermal | 110 | 106 | 110 | 108 | 103 | 105 | 103 | 100 | 110 | 90 | 80 | 100 | 100 | 100 |
| bead | | | | | | | | | | | | | | |
| durability | | | | | | | | | | | | | | |
| Rate of | 0 | 0 | 0 | 0 | 0 | 0 | 0 | 0 | 80 | 0 | 0 | 0 | 0 | 5 |
| incidence | | | | | | | | | | | | | | |
| of | | | | | | | | | | | | | | |
| deficient | | | | | | | | | | | | | | |
| moldings | | | | | | | | | | | | | | |
| <%> | | | | | | | | | | | | | | |

TABLE 4

| | Exam- | Example | Example | Example | Example | Example | Comparative | Example | Example | Example | Example |
|---|---|---|---|---|---|---|---|---|---|---|---|
| | ple C1 | C2 | C3 | C4 | C5 | C6 | Example C1 | C7 | C8 | C9 | 10C |
| Bead structure | Bead | Bead | Bead | Bead | Bead | Bead | Bead wind | Bead | Bead | Bead | Bead |
| | wind | wind | wind | wind | wind | wind | (FIG. 4) | wind | wind | wind | wind |
| | (FIG. 2) | (FIG. 2) | (FIG. 2) | (FIG. 2) | (FIG. 2) | (FIG. 2) | | (FIG. 2) | (FIG. 2) | (FIG. 2) | (FIG. 2) |
| Height La | 7 | 7 | 7 | 7 | 7 | 7 | — | 7 | 7 | 7 | 7 |
| <mm> | | | | | | | | | | | |
| Space Lb <mm> | 7 | 7 | 7 | 4 | 12 | 7 | — | 7 | 7 | 20 | 7 |
| Cushion rubber | | | | | | | | | | | |
| Complex | 7 | 7 | 7 | 7 | 7 | 7 | — | 7 | 7 | 7 | 7 |
| elastic | | | | | | | | | | | |
| modulus E1* | | | | | | | | | | | |
| <MPa> | | | | | | | | | | | |
| Bead | | | | | | | | | | | |
| reinforcing | | | | | | | | | | | |
| layer | | | | | | | | | | | |
| Height Hi | 40 | 40 | 40 | 40 | 40 | 55 | — | 40 | 40 | 40 | 75 |
| <mm> | | | | | | | | | | | |
| Height Ho | 30 | 20 | 38 | 30 | 30 | 30 | — | 12 | 48 | 30 | 30 |
| <mm> | | | | | | | | | | | |
| (ratio Ho/hm) | 25% | 17% | 32% | 25% | 25% | 25% | — | 10% | 40% | 25% | 25% |
| Bead strength | 125 | 125 | 125 | 125 | 125 | 125 | 100 | 125 | 125 | 100 | 125 |
| Bead | 120 | 110 | 120 | 120 | 110 | 125 | 100 | 120 | 120 | 95 | 120 |
| durability | | | | | | | | | | | |
| (general) | | | | | | | | | | | |
| Thermal bead | 110 | 106 | 115 | 110 | 105 | 115 | 100 | 100 | 110 | 90 | 110 |
| durability | | | | | | | | | | | |
| Rate of | 0 | 0 | 0 | 0 | 0 | 0 | 0 | 0 | 0 | 0 | 0 |
| incidence of | | | | | | | | | | | |
| deficient | | | | | | | | | | | |
| moldings <%> | | | | | | | | | | | |
| Longitudinal | 105 | 104 | 107 | 105 | 105 | 108 | 100 | 103.5 | 112 | 105 | 115 |
| spring | | | | | | | | | | | |
| constant | | | | | | | | | | | |
| (N/mm) | | | | | | | | | | | |

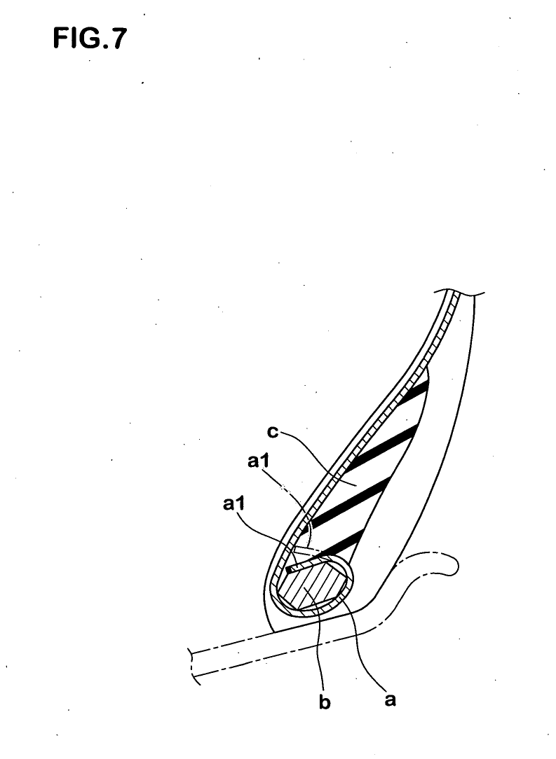

TABLE 5

| | | Example | Example | Example | Example | Comparative | Example | Example | Example |
|---|---|---|---|---|---|---|---|---|---|
| | | D1 | D2 | D3 | D4 | Example D1 | D5 | D6 | D7 |
| Bead structure | | Bead wind | Bead wind | Bead wind | Bead wind | Bead wind | Bead wind | Bead wind | Bead wind |
| | | (FIG. 2) | (FIG. 2) | (FIG. 2) | (FIG. 2) | (FIG. 7) | (FIG. 2) | (FIG. 2) | (FIG. 2) |
| Angle θ (degree) | | 40 | 40 | 40 | 40 | — | 40 | 40 | 40 |
| Height La <mm> | | 6.0 | 6.0 | 6.0 | 6.0 | — | 6.0 | 6.0 | 6.0 |
| Space Lb <mm> | | 2.0 | 2.0 | 2.0 | 2.0 | — | 2.0 | 2.0 | 2.0 |
| Complex elastic | | 15 | 4 | 15 | 20 | — | 8 | 5 | 8 |
| modulus E1* of | | | | | | | | | |
| cushion rubber <MPa> | | | | | | | | | |
| E3* of inner apex | | 65 | 30 | 18 | 60 | — | 30 | 60 | 60 |
| portion <MPa> | | | | | | | | | |
| E4* of outer apex | | 4.0 | 4.0 | 4.0 | 4.0 | 4.0 | 4.0 | 4.0 | 8.0 |
| portion <MPa> | | | | | | | | | |
| Ratio (E3*/E1*) | | 4.33 | 7.50 | 1.20 | 3.0 | — | 3.75 | 12.0 | 7.5 |
| Test | Bead | 100 | 90 | 115 | 90 | 90 | 120 | 80 | 90 |
| results | durability | | | | | | | | |
| | (general) | | | | | | | | |
| | Thermal | 100 | 80 | 90 | 105 | 80 | 100 | 105 | 110 |
| | bead | | | | | | | | |
| | durability | | | | | | | | |

*Tire sectional height = 240 mm, Hb = 95 mm, Ha = 45 mm, Hi = Ho = 27 mm, Hc = 135 mm

1. A heavy duty tire including a carcass ply in which a ply main body portion that extends from a tread portion over a side wall portion up to a bead core of a bead portion is integrally formed with a ply turn-up portion that is turned up around the bead core from inside to outside in an axial direction of the tire,
wherein the ply turn-up portion comprises a main portion, which is bent along an inside surface of the bead core in an axial direction of the tire, a lower surface thereof in a radial direction, and an outside surface thereof in the tire axial direction, and a winding portion, which continues from the main portion and which extends while being spaced from the bead core,
wherein the winding portion extends in an inclined manner with respect to the ply main body portion at an angle θ that is smaller than 90° with respect to an outer surface of the bead core in the radial direction with a height La of a tip end of the winding portion from the outer surface of the bead core in the radial direction being 3 to 15 mm, and
wherein a cushion rubber having a substantially triangular section with a complex elastic modulus E1* at 70° C. of 2 to 25 MPa is disposed in a region surrounded by the outer surface of the bead core in the radial direction, the winding portion, and the ply main body portion.

2. The heavy duty tire as claimed in claim 1, wherein the winding portion is arranged in that a space Lb between the tip end thereof and the ply main body is 1 to 10 mm.

3. The heavy duty tire as claimed in claim 1 or 2, wherein the bead portion comprises a chafer rubber that is disposed in a region extending from a bead bottom surface to an outer surface of the bead for preventing rim displacement, and wherein the chafer rubber has a complex elastic modulus E2* at 70° C. of 11 to 30 MPa and a loss tangent tan δ of 0.1 to 0.7.

4. The heavy duty tire as claimed in claim 1, wherein the bead portion includes a bead reinforcing layer including at least a curved portion that extends along the main portion of the ply turn-up portion and inward thereof in the radial direction and an outer piece that is separated from the main portion outside of the curved portion in the tire axial direction and that inclines outside in the tire axial direction towards outward in the radial direction.

5. The heavy duty tire as claimed in claim 4, wherein a height Ho in the radial direction of the outer piece of the bead reinforcing layer from a bead base line is larger than 20 mm but not more than 40 mm.

6. The heavy duty tire as claimed in claim 4, wherein a height Ho in the radial direction of the outer piece of the bead reinforcing layer from a bead base line is in a range of 15 to 34% of a height hm in the radial direction of a maximum width point Pm of the carcass ply from the bead base line.

7. The heavy duty tire as claimed in claim 5 or 6, wherein the cushion rubber has a complex elastic modulus E1* of 2 to 13 MPa.

8. The heavy duty tire as claimed in claim 1, wherein the cushion rubber has a complex elastic modulus E1* of 8 to 25 MPa, and a sulfur blending amount of not less than 5 phr.

9. The heavy duty tire as claimed in claim 8, wherein a height Ho in the radial direction of the outer piece of the bead reinforcing layer from a bead base line is 5 to 20 mm.

10. The heavy duty tire as claimed in claim 4, wherein the bead reinforcing layer comprises an inner piece inside of the curved portion in the tire axial direction that extends along the inner surface of the ply main portion in the tire axial direction, and wherein a height Hi of the inner piece in the radial direction from a bead base line is not more than 70 mm.

11. The heavy duty tire as claimed in claim 1, wherein the bead portion is arranged in that a bead apex rubber is disposed outside of the cushion rubber in the tire radial direction with the winding portion being interposed between, the bead apex rubber having a complex elastic modulus E3* at 70° C. of 20 to 60 MPa.

12. The heavy duty tire as claimed in claim 11, wherein a ratio between the complex elastic modulus E3* and the complex elastic modulus E1* (E3*/E1*) is not more than 10.

13. The heavy duty tire as claimed in claim 1, wherein the carcass ply and the bead reinforcing layer is comprised of steel cord ply.
